(19) United States
(12) Patent Application Publication
(10) Pub. No.: US 2020/0223112 A1
(43) Pub. Date: Jul. 16, 2020

(54) THERMO-COMPRESSION MOLDING PROCESS AND ASSEMBLY FOR FORMING A TWO PART COMPONENT HAVING AN OPTIONAL RIGID SUBSTRATE AND A SECOND STAGE EXPANDABLE POLYMERIC STRUCTURAL FOAM

(71) Applicant: U.S. Farathane Corporation, Auburn Hills, MI (US)

(72) Inventors: John Klinkman, Auburn Hills, MI (US); Jonathon Dewey, Auburn Hills, MI (US); Wayne Bland, Fort Gratiot, MI (US)

(21) Appl. No.: 16/737,420

(22) Filed: Jan. 8, 2020

Related U.S. Application Data
(60) Provisional application No. 62/790,844, filed on Jan. 10, 2019.

(51) Int. Cl. B29C 44/12; B29C 44/44; B29B 11/08; B29C 44/58

(52) U.S. Cl. CPC B29C 44/12; B29C 44/445; B29K 2101/12; B29C 44/58; B29B 11/08

(57) ABSTRACT

A compression molding technique, assembly and method for producing an acoustic/environmental sealing component, such as for use in a vehicle pillar. A two part mold defines a negative impression cavity of the completed part and within which is deposited a compounded and expandable resin as any of loose beads, granules or a syrup. The resin is heated within the mold to a temperature below that necessary for it activation/expansion, concurrent with being compression formed. A pre-formed rigid substrate not limited to a nylon is incorporated into the mold and against which is compression formed the resin.

### CROSS REFERENCE TO RELATED APPLICATIONS

The present application claims the priority of U.S. Ser. No. 62/790,844 filed Jan. 10, 2019.

### FIELD OF THE INVENTION

The present invention is concerned with compression molding techniques, assemblies and methods for producing an acoustic/environmental sealing component such as for use in a vehicle pillar. The compression molding and assembly utilizes a two part mold defining a cavity seating a first pre-formed rigid substrate, such as a single shot injection molded thermoplastic part not limited to a nylon. A compounded expandable resin, such as foam beads, is positioned within the mold, the spaced side walls of which define the dimensions of the second shot/compression cavity. The resin beads are then heated to a predetermined temperature, such as by oven, infra-red or hot air, causing the beads to become softened and compression moldable. A core compression portion of the mold, which can include without limitation the end projections associated with the male portion of the die, subsequently compresses and bonds the heated/softened beads into one solid mass, such as which is adhesively attached to the original rigid substrate, the completed part subsequently being cooled within the tool cavity to a sufficiently lowered temperature to be removed.

### BACKGROUND OF THE INVENTION

The prior art is concerned with numerous examples of two part structural components for use in such as a vehicle pillar or other acoustic/environmental sealing applications. One known type of material includes EPDM rubber (Ethylene Propylene Diene Monomer rubber), which is a high-density synthetic rubber exhibiting desired dynamic and mechanical properties.

Werner U.S. Pat. No. 9,427,902 (L&L/Zephyros) teaches one known feature for providing a foamable material upon a foil layer which is turn pre-placed within the pillar cavity and, as known, typically heat expanded in order to fill its interior. The cavity filler insert of WO 2007/146726 (Henkel) is similar and teaches a carrier supporting a thermally expandable foam material pre-arranged within the cavity interior prior to heating/expansion. These designs are basically representative of the prior art in this area.

WO 2014/096966 (Henkel) is interesting and teaches a heat resistant composed injection molded carrier (see at 9), within the sides of which are formed receptacles arranged in a grid or lattice pattern for receiving heat expandable resin inserts. A similar arrangement of mounting portions (see at 20) are provided for fastening the molded part to an interior wall of the hollow chamber within which the part is mounted in use.

U.S. Pat. No. 9,713,885 (L&L/Zephyros) teaches a baffling/sealing device having a first material of constant thickness, with a second expandable (foam) material bonded to the first material and having a lower rigidity. Fasteners are attached to or formed with the materials in order to support the article so that its outer perimeter fits within the cross section of the cavity and in which the body can be deformed in a manner in which the first material retains its shape at elevated temperatures.

Czaplicki, U.S. Pat. No. 6,668,457, teaches a reinforced hydroform member having an outer structural member reinforced by a structural foam supported by the outer member. The foam extends along at least a portion of the length of the outer member and is a heat-activated epoxy-based resin. As the foam is heated, it expands and adheres to adjacent surfaces.

WO 2015/157250 (Honda) teaches an elongated and hollow frame member formed from a thermoplastic polymer and installed within the elongated hollow interior of the frame member in a plane orthogonal relative to a longitudinal axis of the elongated frame member.

Another interesting design is Birka 2016/0288387 which teaches a co-injected molded part (such as a bumper fascia) with an outer skin 14 and a lower density inner core 16. A number of structural differences from what the present design is trying to accomplish however worth taking a closer look at. Spengler U.S. Pat. No. 6,287,678 teaches a structural panel similar in numerous respects to Birka.

### SUMMARY OF THE INVENTION

The present invention teaches each of a method and assembly for forming a compression molding for use as an acoustic/environmental sealing component, further not limited to use in a vehicle pillar. As previously described, the compression molding and assembly utilizes a two part mold defining a cavity seating, in a non-limiting variant, a first pre-formed rigid substrate such as a single shot injection molded thermoplastic part not limited to a nylon.

A compounded expandable resin can, according to one non-limiting variant, be provided by a plurality of foam beads which is positioned within the mold (such as via any of vacuum drawing, injection molding, etc.) in contact with desired locations of the pre-placed rigid substrate, and such that the spaced interior side walls of the mold define the dimensions of the second shot/compression cavity. In an alternate embodiment, no rigid substrate is inserted apart from the depositing of the resin beads so that the cavity contours reflect the finished dimensions of the compounded expandable resin only (the rigid substrate being optionally attached or bonded later in a separate fabrication operation).

In either variant, the resin beads are heated to a predetermined temperature, such as by oven, infra-red or hot air, causing the beads to become softened and compression moldable. Heating/softening of the resin beads is further understood to be conducted at a temperature below that typically required for catalyzing the active ingredient in the compounded resin in order to cause it to expand, this typically desired once the finished component is produced and then installed within the vehicle pillar or the like, following which it is subjected to a heat bake temperature requirement of temperatures commonly above 200° F. and during which such operation the expansion of the resin occurs in order to fill the interior of the pillar cavity within which the compression formed resin is installed or pre-placed.

In operation, a core compression portion of the mold subsequently compresses and bonds the heated/softened/pre-expanding beads into one solid mass, these separately produced or, in certain variants, adhesively attached to the original rigid substrate which is subsequently cooled within the tool cavity to a sufficiently lowered temperature to be removed. Accordingly, the present inventions include the non-limiting variant of placing a rigid substrate base (nylon, etc.) into an injection mold, the spaced and surrounding walls of which correspond to the completed part.

The foam material (such as in the form of resin beads) can, as previously described, be alternatively injected or deposited into the cavity interior (via any of injection, pouring, gravity feeding, or vacuum introduction) and, subsequently, a dynamic compressive force (such as associated with the core compression portion) is exerted by the associated compression tool in order to compress the heat expanded foam beads into a solid mass which is caused to be adhesively secured to the original substrate part. The present concept allows for the production of thermoplastic based parts at similar cost and efficiency, as compared to competing processes and assemblies for creating more tricky EPDM style components

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a plan view of a thermo-compression molded part produced according to one non-limited variant of the present invention;

FIG. 2 is a rotated perspective of the part depicted in FIG. 1 and illustrated a rigid (nylon) substrate with an outer skirt of heat reactive foam beads forming a thermoplastic expandable acoustic and structural foam skirt;

FIG. 3 is a one-hundred and eighty degree rotated plan view to that shown in FIG. 1 and depicting a rear side of the rigid substrate material including mounting features;

FIG. 4 is a ninety degree rotated view of the part depicted in FIG. 2;

FIG. 5 is a cutaway plan view of a two part die assembly depicting a nylon rigid substrate material in combination with a foam resin bead trim according to one non-limiting variant of the present invention;

FIG. 6 is an illustration of a combination rigid and structural supporting thermoplastic substrate in combination with an array of expandable structural foam resin beads in a pre-compressive formed configuration;

FIG. 7 is a succeeding view to FIG. 6 and depicting the compressive reforming of the foam resin beads, such as in a perimeter defined fashion with respect to the rigid and structural supporting substrate, in a pre-heat bake expanded configuration;

FIG. 8 is an exploded view of a two part mold assembly for producing a compressed heat reactive expandable foam material according to a non-limiting embodiment of the present invention;

FIG. 9 is a partial cutaway perspective of an assembled two part mold as shown in FIG. 8 and depicting a hard structural frame received within the mold prior to introduction of the resin foam material;

FIG. 10 is a partial cutaway of an assembled two part mold as shown in FIG. 8 not including a structural frame or insert, and illustrating open dimensions in the lower female/cavity mold corresponding to the compression formed resin structural foam;

FIG. 11 is a further partial assembled view of FIG. 9 of the substrate loaded into the tool;

FIG. 12 is a partial exploded view of the related variant of FIG. 10;

FIG. 13 is a similar view to FIG. 11 with the resin material pre-loaded into the cavity;

FIG. 14 is a similar view of the variant of FIG. 12 with the resin material loaded into the female mold cavity;

FIG. 15 is a succeeding illustration to FIG. 13 and illustrating the die tool beginning to close in order to compression form the inserted resin bead material against the rigid substrate;

FIG. 16 similarly provides a succeeding illustration to FIG. 14 and again depicting the die tool of the alternate embodiment of the variant of FIG. 10 in the intermediate closing position to compression form the inserted resin bead material;

FIG. 17 is a further succeeding view to FIG. 15 of the tool in a fully closed position in order to compression mold the injected resin material into its finished shape, such as about the perimeter of the rigid inserted substrate material;

FIG. 18 is a similarly further succeeding view to FIG. 16 depicting the tool in a fully closed position in order to compression mold the individual structural resin foam beads into their final configurations;

FIG. 19 is an illustration of the finished part in FIG. 17 removed from the die tool;

FIG. 20 is an concurrent illustration of the finished part in FIG. 18 removed from the die tool;

FIG. 21 is an illustration of the finished part produced by the mold assembly of FIG. 9 removed from the tool;

FIG. 22 is an illustration of the finished part produced by the mold assembly of FIG. 10 removed from the tool;

FIG. 23 is an illustration of a sandwich die mold according to a non-limited variant of the present invention and depicting a configuration of an eventual resin structural foam layering produced within the mold;

FIG. 24 is a rotated and pre-assembled view of the sandwich die mold of FIG. 23;

FIG. 25 is a plan view similar to FIG. 23 of the sandwich mold halves and better illustrating their opposing contours for receiving and producing the eventual compression molded resin structural foam layer;

FIG. 26 is an illustration of a vehicle pillar such as which integrates the compression molded structural foam material; and

FIG. 27 is an illustration of an irregular of a resin structural foam layer, such as capable of being produced by the die mold of FIG. 10.

### DETAILED DESCRIPTION OF THE PREFERRED EMBODIMENTS

With reference to the attached figures, the present invention discloses a compression molding for forming such as an acoustic/environmental sealing component, not limited to use in a vehicle pillar. As previously described, the compression molding and assembly utilizes a two part mold defining a cavity seating, in a non-limiting variant, and can optionally utilize a first pre-formed rigid substrate, such as a single shot injection molded thermoplastic part not limited to a nylon.

A compounded expandable resin, such as provided by a plurality of foam beads, is positioned within the mold in contact with desired contact locations of the pre-placed rigid substrate, and in which instance the spaced side walls of which define the dimensions of the second shot/compression cavity. In an alternate embodiment, no rigid substrate is inserted apart from the depositing of the resin beads so that the cavity contours reflect the finished dimensions of the compounded expandable resin only.

In either variant, the resin beads are heated to a predetermined temperature, such as by oven, infra-red or hot air, which causes the beads to become softened and compression moldable. Heating/softening of the resin beads is further understood to be conducted at a temperature below that typically required for catalyzing the active ingredient in the compounded resin which is required to occur in order to cause it to expand. The subsequent expansion of the foam resin is typically desired once the finished component is produced and then installed within the vehicle pillar or the like and then subjected to a requisite degree of heat, such as associated in one non-limited application with a heat bake temperature requirement of temperature commonly above 200° F. A core compression portion of the mold subsequently compresses and bonds the heated/softened beads into one solid mass which is adhesively or otherwise attached to the original rigid substrate and is subsequently cooled within the tool cavity to a sufficiently lowered temperature to be removed.

As is further known, expanded polymeric bead foams are popular materials used in packaging and thermal and sound insulation applications. Expandable polystyrene (EPS), expanded polyethylene (EPE), and expanded polypropylene (EPP) are other widely used modern moldable bead foams. The successful commercialization of EPP has led to the application of polymeric bead foams into more advanced applications in areas such as automotive production

Accordingly, the present concept focuses on placing a rigid substrate base (nylon, etc.) into an injection mold, the spaced and surrounding walls of which correspond to the desired dimensions of the completed part. The foam material (such as in the form of resin beads not limited to EPS, EPE, EPP or the like) can further be injected or deposited into the cavity interior (via injection, pouring, gravity feeding, or vacuum introduction) and, subsequently, a dynamic compressive force (such as associated with the core compression portion) is exerted by the compression tool in order to compress the heat expanded foam beads into a solid mass which is adhesively secured to the original substrate part. In this manner, the present inventions allow for the production of thermoplastic based parts at similar cost and efficiency as compared to competing processes and assemblies for creating more tricky EPDM style components.

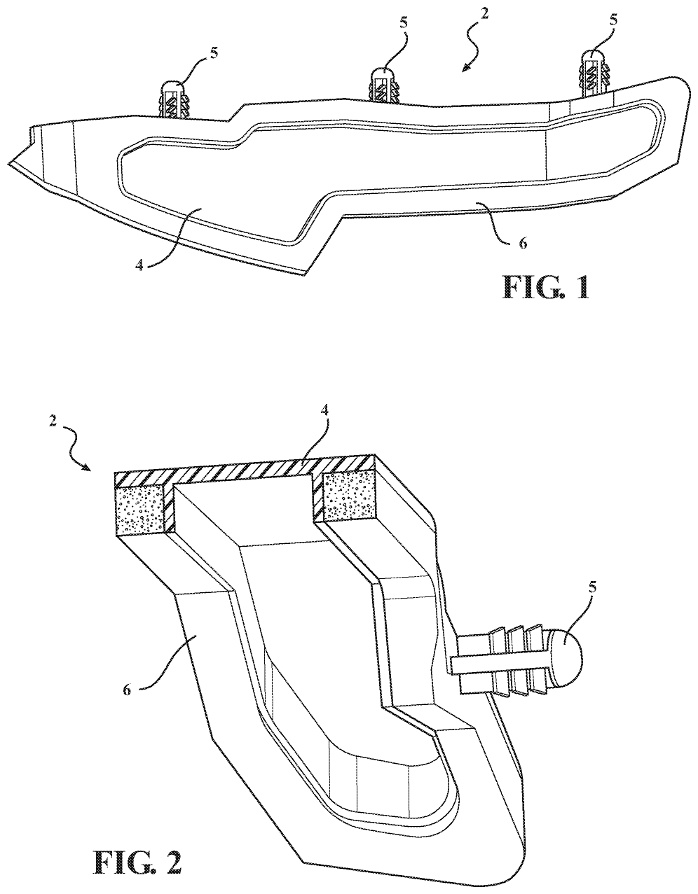

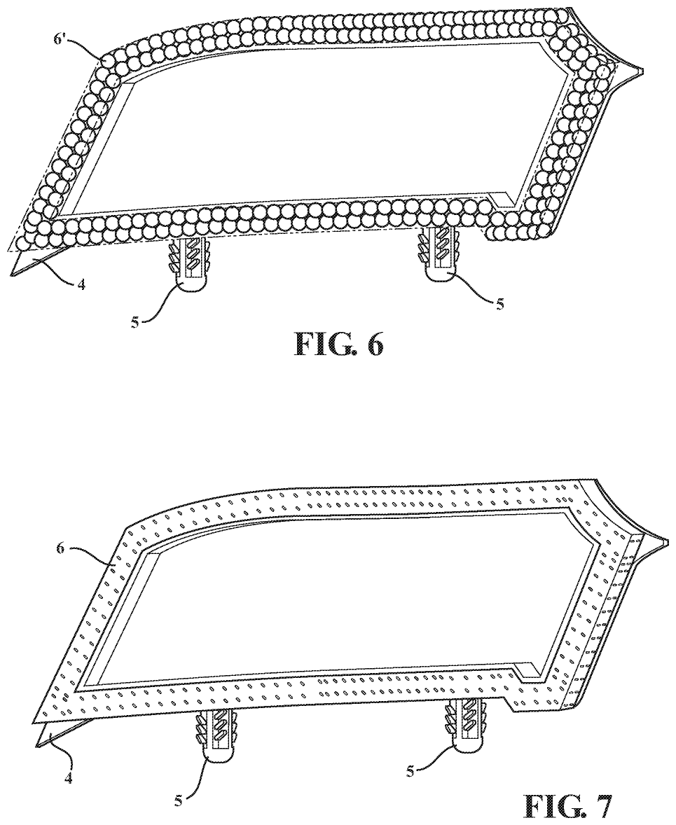

Referencing initially FIG. 1, a plan view is generally shown at 2 of a thermo-compression molded part produced according to one non-limited variant of the present invention. In combination with the perspective of FIG. 2, the part depicted includes a substrate which, without limitation, can include any material exhibiting a rigidity greater than that associated with the resin material. The substrate can, in one non-limiting application, include a rigid nylon 4, such as to which is attached an outer skirt of heat reactive foam beads (subsequent reference also being had to pre-heated and pre-compressed beads 6′ in FIG. 6). It is further noted that the beads 6 depicted in FIGS. 1-4 are presented in a completed compression molded shaping such as for subsequent placement within a vehicle pillar cavity for employing in a future heat-bake (paint drying) operation during which the resin expands and forms a thermoplastic expandable acoustic and structural foam skirt. As will be further described, the rigid substrate 4 can be pre-produced in a separate thermoforming (injection molding, extruding, etc.) process.

The rigid substrate 4 can also include mounting features, see as shown at 5, which are configured to mount the substrate and associated resin bead thermoformed skirt 6 in such as fashion that the subsequent expansion process (heat paint bake, etc.,) provides for a desired degree of expansion of the foam resin material from its compressed shape to its eventual expanded (sealing and acoustic/environmental protecting) profile within the desired vehicle pillar or other installation environment.

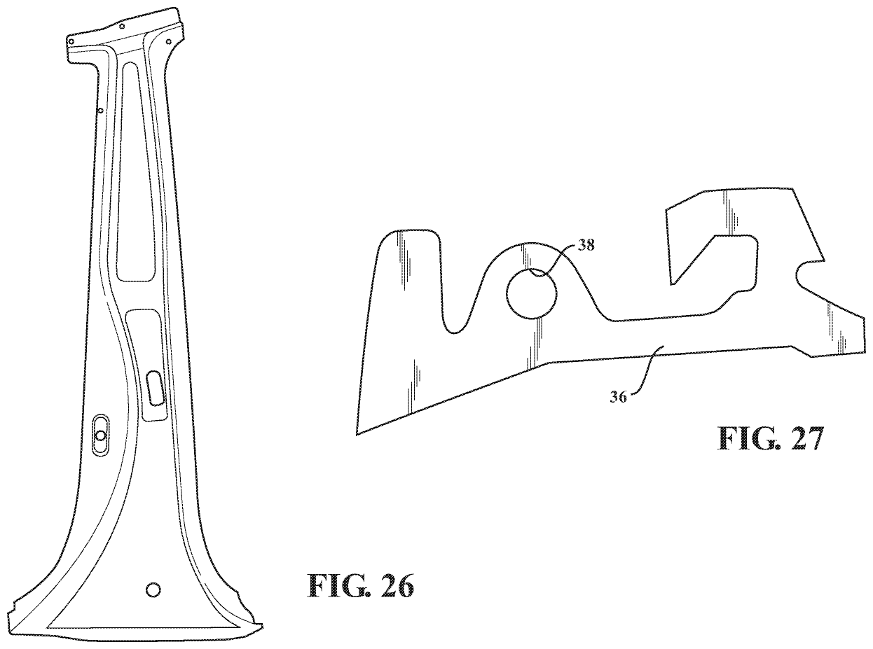

FIG. 26 provides an example of an illustration of a vehicle pillar 1, such as which integrates the compression molded structural foam material. Without limitation, the thermos-compression moldings can be reconfigured for eventual use in a variety of installation environments, not limited to vehicle pillar insulation and acoustic sealing environments.

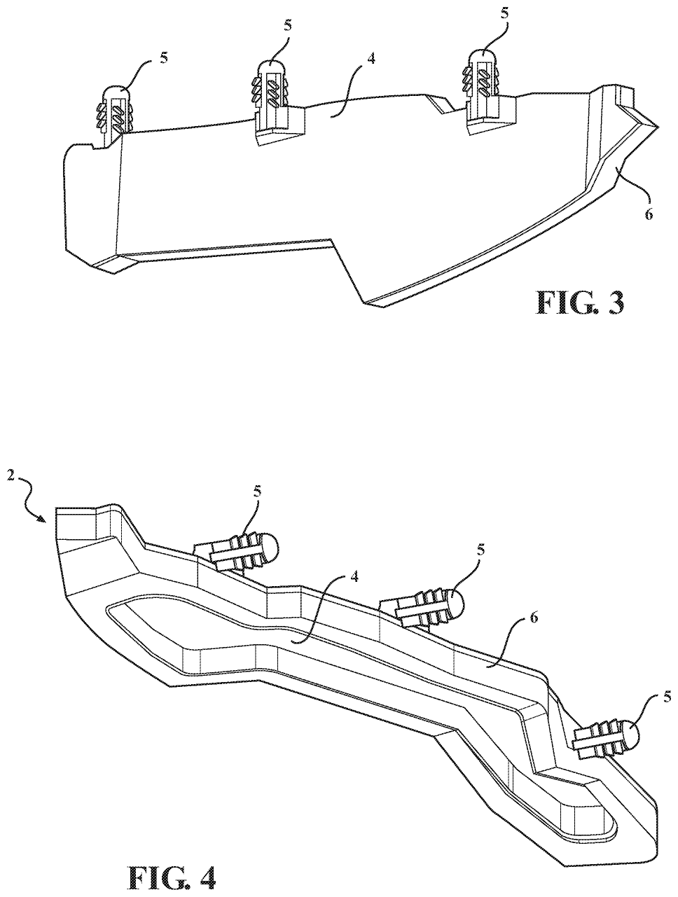

FIG. 3 is a one-hundred and eighty degree rotated plan view to that shown in FIG. 1 and depicting a rear side of the rigid substrate material 4, and again including mounting features 5 as well as the resin material 6 which is compression formed from a pre-heated, pre-compressed plurality of beads 6. FIG. 4 is a further ninety degree rotated view of the part depicted in FIG. 2 and showing the non-limiting configuration of the rigid substrate 4 with IM molded mounting features 5 in combination with the thermoformed attachable resin bead layer 6 (further shown as a skirt extending around a perimeter of the rigid substrate).

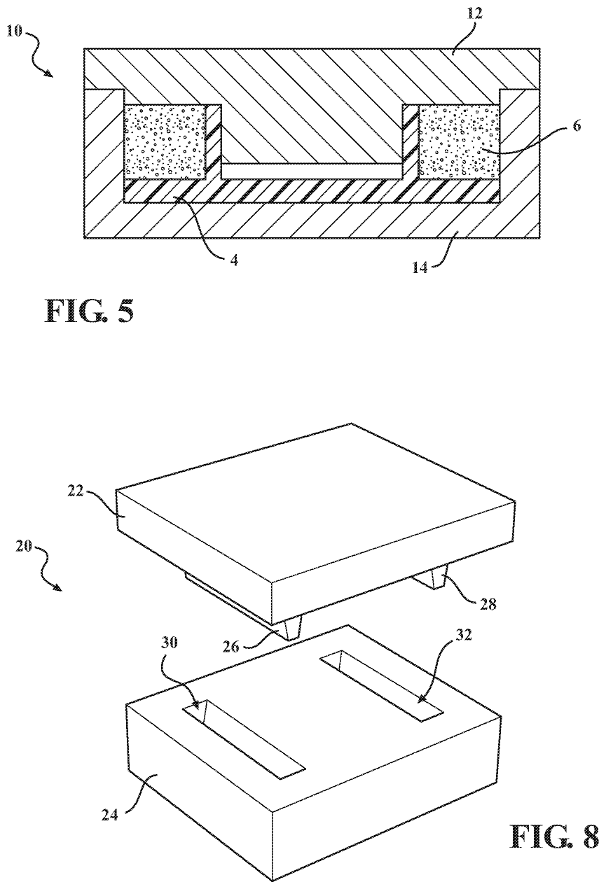

Proceeding to FIG. 5, a cutaway plan view is generally shown at 10 of a two part die assembly depicting the nylon rigid substrate material, such as again shown at 4, in combination with the foam resin bead trim 6 according to one non-limiting variant of the present invention. The die assembly includes an upper die half 12 and a lower die half 14, the inner walls of which define the interior cavity of the eventually heat expanded and finish produced part (this again following pre-expanded compression forming in the mold, followed by installation within the vehicle pillar cavity and then subsequent heat-activated expansion such as associated with a separate heat bake or paint drying operation).

As previously described, the substrate or rigid part 4 can be pre-produced in a separate injection molding, stamping, extrusion or other process prior to introduction of the foam resin beads 6′. As previously described, the foam beads can be introduced into the mold cavity in any manner not limited to any of vacuum drawing, injecting or pour-in depositing. It is also envisioned that the beads can be pre-configured with a binder and attached to the desired locations of the rigid substrate (see FIG. 6) prior to heating/softening and compression molding.

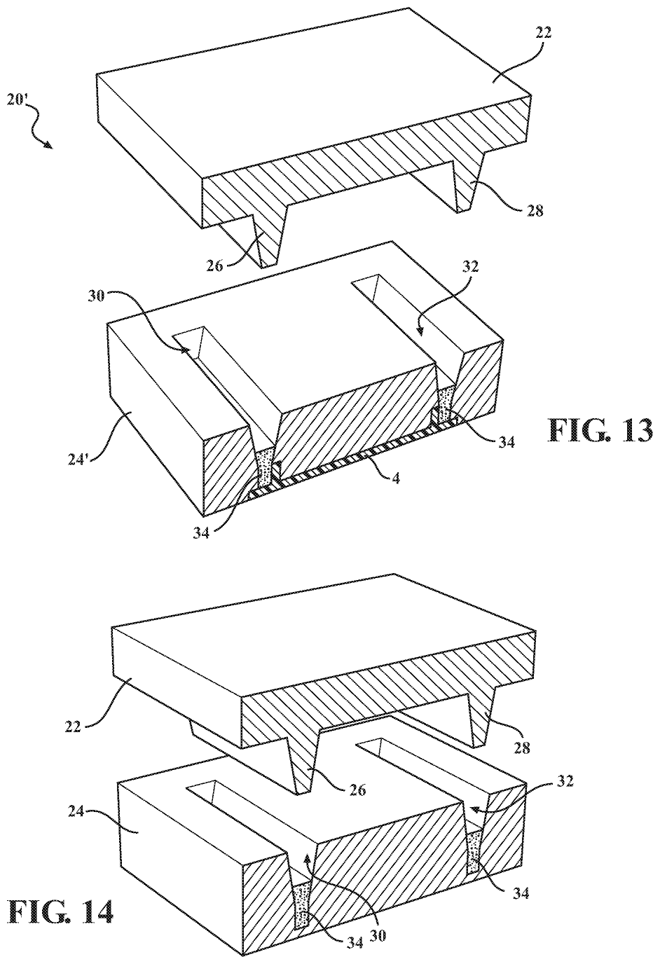

FIG. 6 provides an illustration of the combination rigid and structural supporting thermoplastic substrate 4 with an array of expandable structural foam resin beads (here depicted in a pre-compression formed state 6′) and according to a pre-compressive formed configuration. In this illustration, and alternate to being deposited within the mold (see FIG. 13), the beads 6′ are pre-attached as a skirt to an extending surface of the more rigid substrate 4.

FIG. 7 is a succeeding view to FIG. 6 and depicts the compressive reforming of the foam resin beads, such as in a perimeter defined fashion with respect to the rigid and structural supporting substrate, in a compressive reformed and pre-heat bake expanded configuration, at 6″ and which further corresponds to the depicts previously at 6 in FIGS. 1-4.

Proceeding to FIG. 8, an exploded view is shown of a further variant, generally at 20, of a two part mold assembly including an upper die 22 and a lower die 24 for producing a compressed heat reactive expandable foam material according to a non-limiting embodiment of the present invention. The upper mold 22 exhibits a pair of downwardly projecting engaging portions 26 and 28, with the lower mold 24 exhibiting seating cavities (see at 30 and 32) which, upon assembly of the upper mold, receive the downwardly engaging portions 26/28 within the cavity in a desired dimensional defining relationship corresponding to the finished part to be produced.

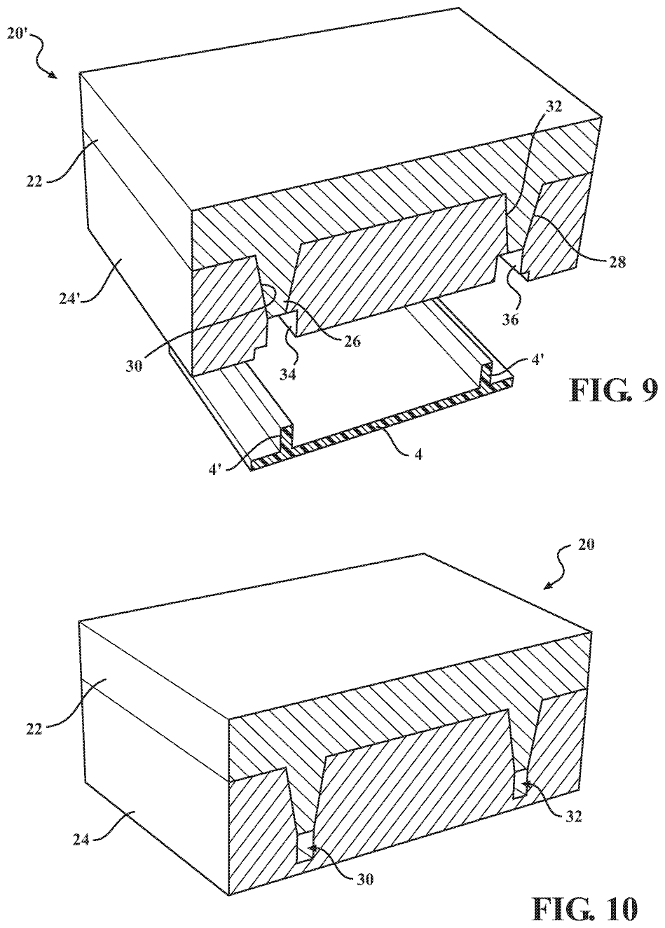

Proceeding to FIG. 9, a partial exploded perspective is shown of an assembled two part mold, depicted at 20′ and similar to as shown in FIG. 8, and with the upper die 22 and a redesigned lower die, further at 24′. A hard structural frame or insert, again at 4 as further previously illustrated, is received within the lower die half 24′ of the mold (such as which can be staged to the tool) prior to introduction of the resin foam material.

As further shown in FIG. 9, the lower die half 24′ can also include a lower open reconfiguration (see recess patterns 34 and 36) which correspond to receiving the rigid preformed insert 4 (such further depicting projecting locations 4′ from the main planar body of the insert 4 which integrates the substrate 4 into the lower half 24′ of the die tool) and in order to define a remaining inner cavity space within the mold corresponding to the thermo-compression of the heated/softened (and pre-expanded) foam resin material (not shown in this view).

FIG. 10 is a partial cutaway of an assembled two part mold (upper half 22 and lower half 24), as previously shown in FIG. 8 and not including a structural frame or insert. The partial cutaway aspect of FIG. 10 further illustrates the open dimensions (see again at 30 and 32) in the lower female/cavity mold 24 which correspond to the eventual compression formed resin structural foam (also not shown in this view).

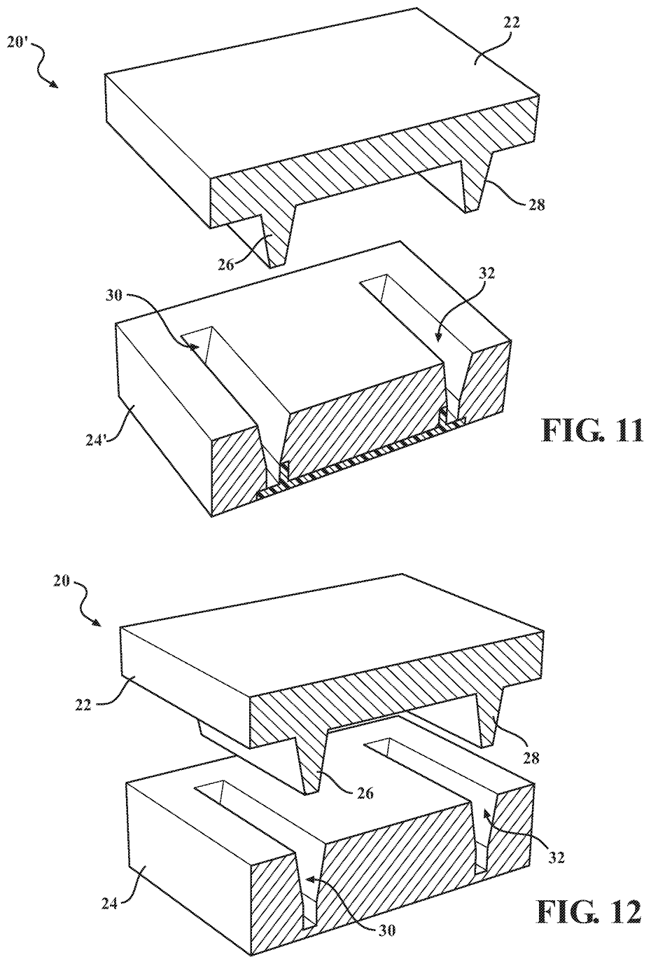

FIG. 11 is a further partial assembled view of the substrate 4 loaded into the tool (lower die half 24′ in the manner depicted in FIG. 9). FIG. 12 is a partial exploded view of the related variant of FIG. 10.

FIG. 13 is a similar and succeeding view to FIG. 11, depicting the resin material (shown as any of a bead, granular or soup-like composition 34) pre-loaded into the cavities 32/34 defined in the lower die half 24′. As shown, the volumes of fluidic resin material 34 are pre-measured before being introduced within the mold interior (such as according to any technique not limited to pouring but also including vacuum introduction, injection at some pressure or other technique). FIG. 14 further provides a similar view of the variant of FIG. 12 with the resin material, again at 34 loaded into the originally disclosed version 24 of the female mold cavity in FIG. 8.

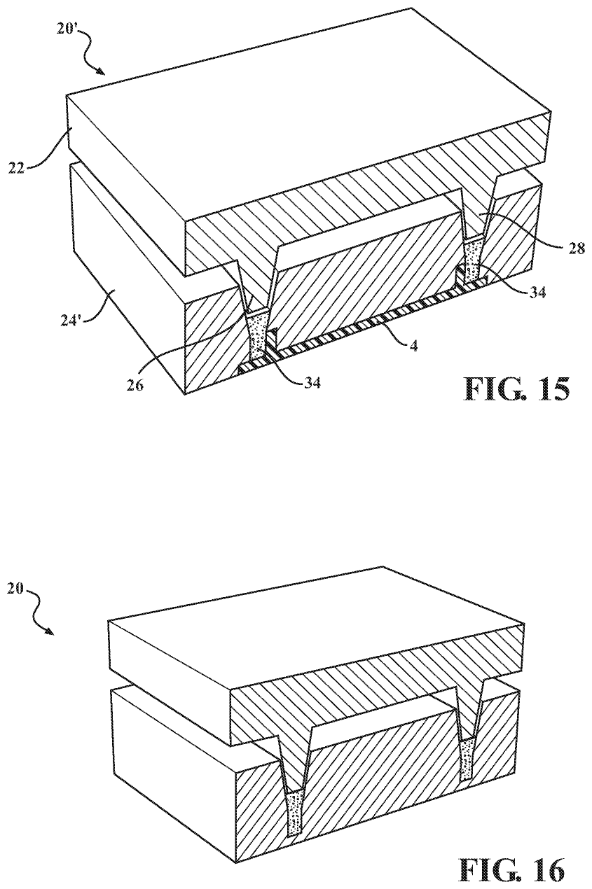

Proceeding to FIG. 15, a succeeding illustration to FIG. 13 depicts the die tool (upper half 22) beginning to close in order to compression form the inserted resin (bead or soup or granule) material 34 against the rigid substrate and according to the confines of the remaining cavities 30/32 defined between the mating mold halves. FIG. 16 similarly provides a succeeding illustration to FIG. 14 and again depicting the die tool 20′ of the alternate embodiment of the variant of FIG. 10 in the intermediate closing position to compression form the inserted resin bead material.

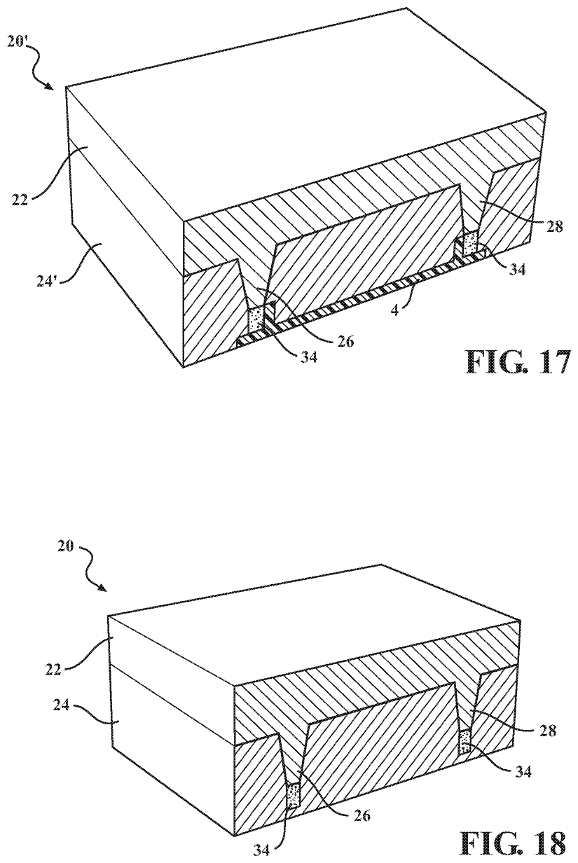

FIG. 17 is a further succeeding view to FIG. 15 of the tool in a fully closed position in order to compression mold the injected (beaded, granular, syrup) resin material 34 into its finished shape, such as about the perimeter of the rigid inserted substrate material 4. FIG. 18 is a similarly further succeeding view to FIG. 16 depicting the tool in a fully closed position, again in order to compression mold the individual structural resin foam beads into their final configurations.

In each instance, the compressed resin foam 34 corresponds to that shown at 6 in each of FIGS. 1-4. It is also again understood that the compression forming of the resin foam material can include the die halves 22/24 being heated to a desired degree, this typically below the 200° F. or above which is usually associated with the thermal expansion of the foam, and once the part (see again FIGS. 1-4) is placed within a vehicle pillar (see again as shown at 1 in FIG. 26) according to a subsequent heat bake aspect of a paint drying operation.

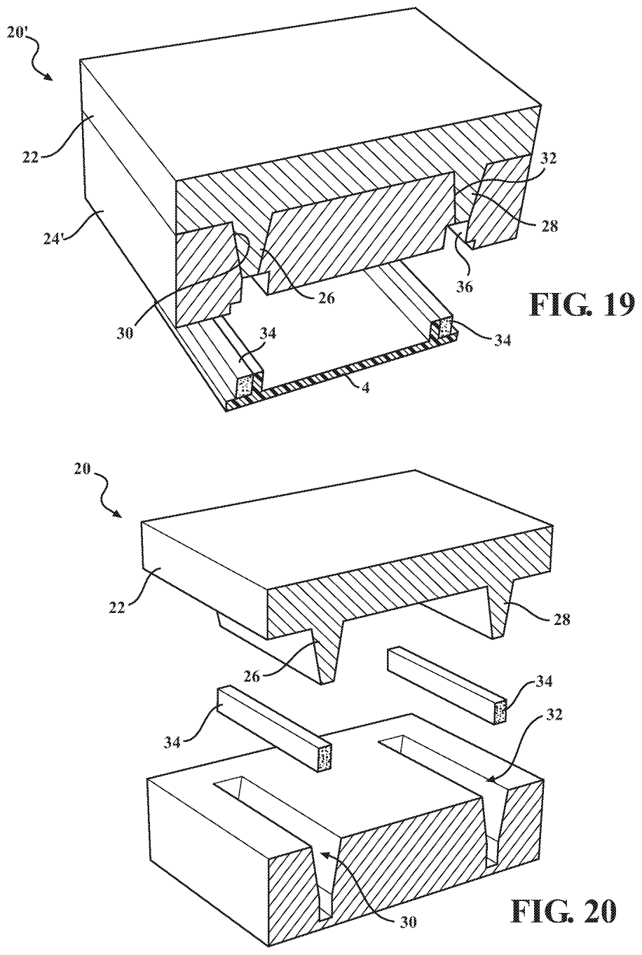

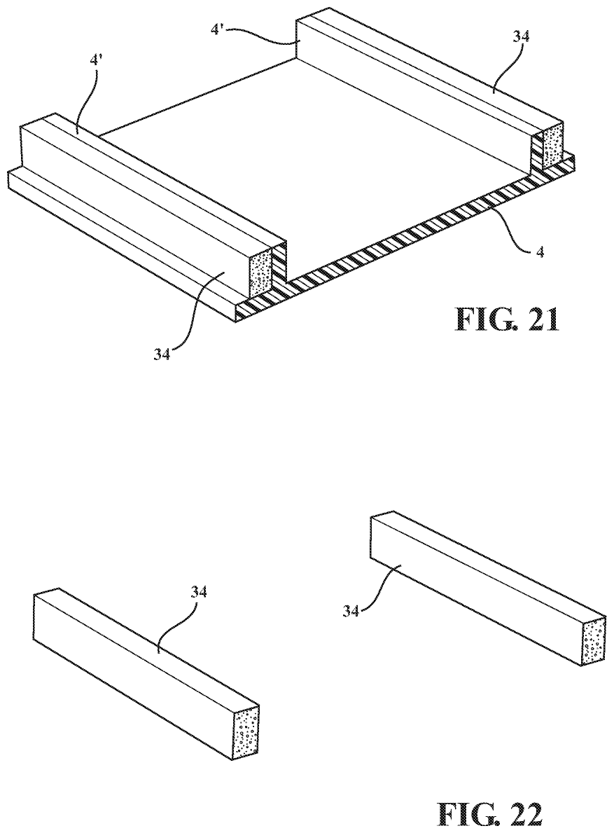

FIG. 19 (along with FIG. 21) is an illustration of the finished part (substrate 4 and attached and compression formed resin beaded portions 34) in FIG. 17 removed from the die tool 20′. The related variant of FIG. 20 (along with FIG. 22) correspondingly illustrates the finished parts in FIG. 18 (compression formed resin foam portions 34) removed from the die tool.

Beyond the example shown at 34 in FIGS. 20 and 22, FIG. 27 provides an illustration of another irregular shape of a compression formed and resin structural foam layer, depicted at 36 and such as capable of being produced by the die mold of FIG. 10. The contours of the resin layer 36, such as which can be designed to be heat expanded into any desired interior space not limited to a vehicle pillar 1 or other interior confine, may include any thickness or layering (thin as shown) with further irregular profiles and cutout locations (see as further defined by inner closed perimeter surface 38). By this example, the present invention makes possible the formation of any compression molded resin foam structure (not limited to shape or configuration) and which can be utilized with or separately from a rigid substrate in order to provide a desired insert for a pillar or other confined space which is heat (paint bake, etc.) expanded into a desired environmental/acoustic sealing arrangement.

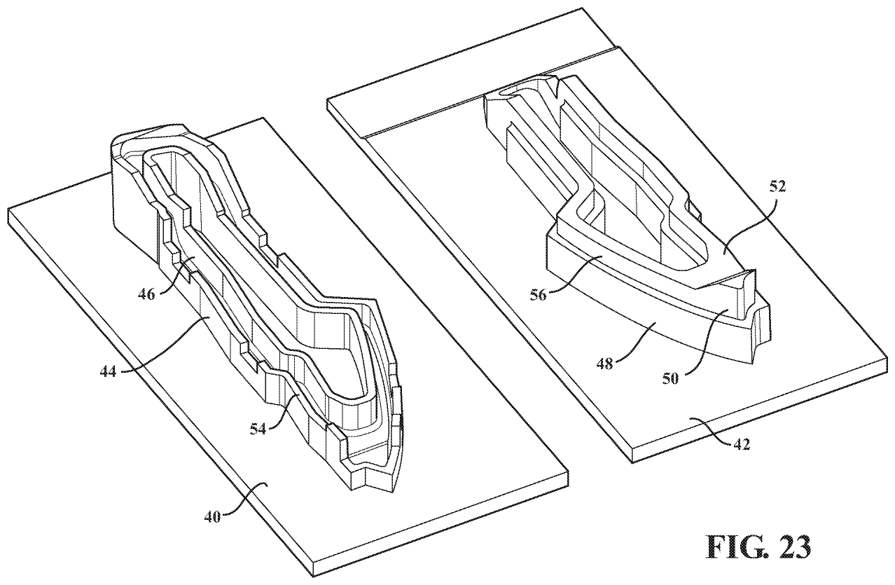

FIGS. 23-25 present a series of perspective and plan view illustrations of a two piece die according to a more representative configuration and including a first die or mold half 40 and a second opposing die or lower mold half 42. Without limitation, the opposing mold halves 40/42 can be arrayed in any fashion, with either qualifying as an upper or lower mold half within the scope of the present description, such further depicting a configuration of an eventual resin structural foam layering produced within the mold.

The mold halves 40/42 can each be constructed of a desired heat impervious material not limited to metals and/or ceramics provided separately or in combination. The opposing die configurations can include the mold halves each including a relatively thin base plate, this including the mold half 40 exhibiting a pair of outer 44 and inner 46 irregular perimeter projecting and extending patterns. The mold half 42 likewise exhibits a further perimeter extending pattern with irregular stepped and tiered and upwardly projecting profiles 48, 50 and 52 and which, upon arraying the mold half 42 in opposing fashion to the mold half 40, permits the two to be sandwiched together in a fashion which permits an exposed outer rim 54 of the outer perimeter extending pattern 44 in the selected mold half 40 to abut against a corresponding extending rim 56 of the opposing mold half 42.

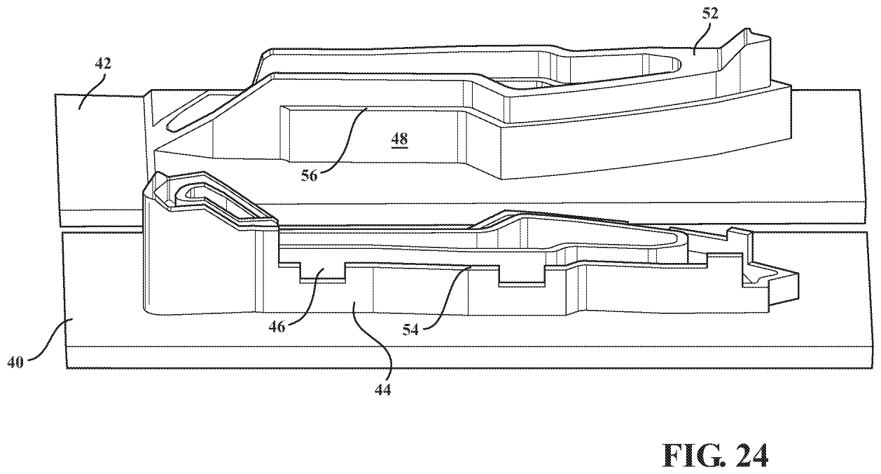

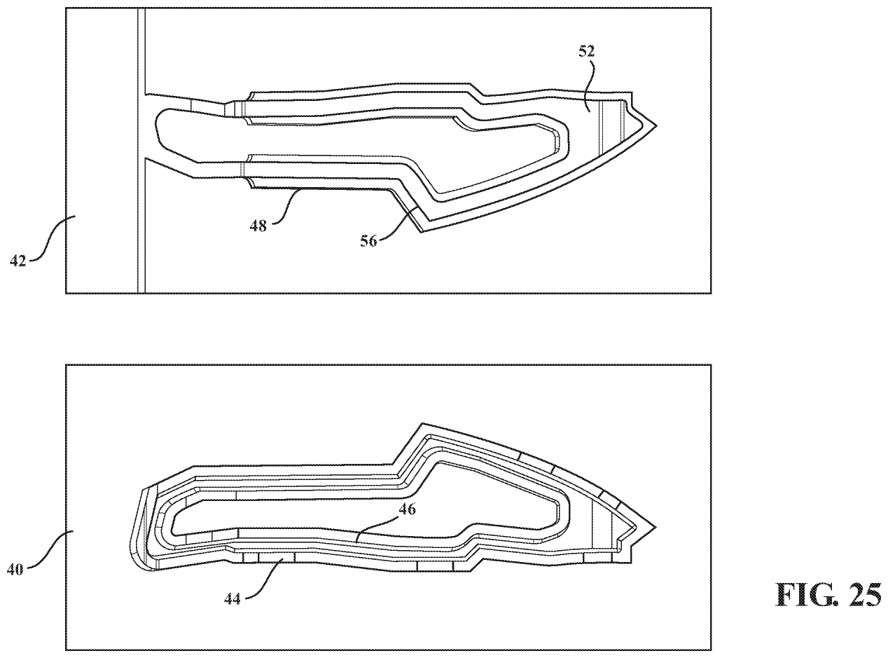

FIG. 24 is a rotated and pre-assembled view of the sandwich die mold of FIG. 23. FIG. 25 further presents a plan view similar to FIG. 23 of the sandwich mold halves and better illustrating their opposing contours for receiving and producing the eventual compression molded resin structural foam layer.

Having described my invention, other and additional preferred embodiments will become apparent to those skilled in the art to which it pertains, and without deviating from the scope of the appended claims.

I claim:

1. A compression molding assembly for producing a sealing component for use in a vehicle pillar, said assembly comprising:
a two part mold defining a negative impression cavity corresponding to a part to be produced;
a compound expandable resin positioned within said cavity;
a pre-formed substrate incorporated into said mold cavity; and
the resin being heated to a temperature below that necessary for activation/expansion and the two part mold being compressed together to adhere the resin to the substrate.

2. The compression molding assembly as described in claim 1, further comprising the resin being deposited within the mold as any of loose beads, granules or a syrup.

3. The compression molding assembly as described in claim 4, the substrate further comprising a single shot injection molded thermoplastic part.

4. The compression molding assembly as described in claim 3, further comprising attachment features integrated into the substrate for post-mounting within a vehicle pillar cavity.

5. The compression molding assembly as described in claim 1, the resin further comprising any of expandable polystyrene, expanded polyethylene, and expanded polypropylene.

6. The compression molding assembly as described in claim 1, the resin further comprising an outer skirt of heat reactive foam beads attached to the substrate.

7. The compression molding assembly as described in claim 1, said two part mold further comprising an upper die and a lower die.

8. The compression molding assembly as described in claim 7, said lower die having an open bottom against which is applied the preformed substrate.

9. The compression molding assembly as described in claim 8, further comprising said upper die having downwardly projecting engaging portions which mate within seating cavities formed in the lower die following positioning of the preformed substrate, the resin being pre-deposited within said lower die and so that, upon progressing closing said upper die within said lower die, compressing of said die halves to a completed position corresponds to achieving the dimensions of the negative impression cavity with the resin bonding to the substrate.

10. The compression molding assembly as described in claim 7, each of said upper and lower dies further comprising a thin base plate, said upper die exhibiting a pair of outer and inner irregular perimeter projecting and extending patterns, said lower die exhibiting a further perimeter extending pattern with irregular stepped and tiered and upwardly projecting profiles which, upon arraying said dies in an opposing sandwiching fashion cause an exposed outer rim of an outer perimeter extending pattern of said upper die to abut against a corresponding extending rim of said lower opposing die.

11. A method for producing a sealing component for use in a vehicle pillar, said assembly comprising:
providing a two part mold defining a negative impression cavity corresponding to a part to be produced;
placing a compounded and expandable resin within the mold cavity;
positioning a substrate relative to the mold so as to be in communication with the cavity;
heating the resin to a temperature below that necessary for activation/expansion; and
progressively closing the two part mold in order to compression form the resin against the rigid substrate until defining a negative impression cavity corresponding to a part to be produced.

12. The method as described in claim 11, said step of depositing the resin further comprising depositing as any of loose beads, granules or a syrup.

13. The method as described in claim 11, further comprising the step of pre-forming the substrate as a single shot injection molded thermoplastic part.

14. The method as described in claim 13, further comprising the step of forming attachment features into the substrate for post-mounting within a cavity of the vehicle pillar.

15. The method as described in claim 11, further comprising the step of providing the resin further as any of an expandable polystyrene, expanded polyethylene, and expanded polypropylene.

16. The method as described in claim 11, said step of placing the resin within the cavity further comprising the steps forming the resin into a skirt of heat reactive foam beads and attaching the skirt to the substrate.

17. The method as described in claim 11, said step of providing a two part mold further comprising configuring the mold to include an upper die and a lower die having an open bottom against which is applied the substrate.

18. The method as described in claim 17, further comprising the step of configuring the upper die to include downwardly projecting engaging portions which mate within seating cavities formed in the lower die and so that, following positioning of the substrate, the resin being pre-deposited within the lower die and so that, upon progressing closing of the upper die within the lower die, compressing of the die halves to a completed position corresponds to achieving the dimensions of the negative impression cavity with the resin bonding to the substrate.

10. The method as described in claim 17, further comprising the step of configuring each of the upper and lower dies to exhibit a thin base plate, the upper die further exhibiting a pair of outer and inner irregular perimeter projecting and extending patterns, the lower die exhibiting a further perimeter extending pattern with irregular stepped and tiered and upwardly projecting profiles which, upon arraying the dies in an opposing sandwiching fashion cause an exposed outer rim of an outer perimeter extending pattern of the upper die to abut against a corresponding extending rim of the lower opposing die.
